(19) United States
(12) Patent Application Publication
(10) Pub. No.: US 2026/0357704 A1
(43) Pub. Date: Nov. 12, 2026

(54) METHOD FOR DETERMINING ASSEMBLY POSITIONS FOR AVAILABLE BLADES AROUND A DISC HUB

(71) Applicant: ROLLS-ROYCE PLC, London (GB)

(72) Inventors: Thomas D. HILTON, Derby (GB); Crispin D. BOLGAR, Derby (GB)

(73) Assignee: ROLLS-ROYCE PLC, London (GB)

(21) Appl. No.: 19/650,461

(22) Filed: Apr. 17, 2026

(30) Foreign Application Priority Data
May 9, 2025 (GB) 2507126.7

(51) Int. Cl. F01D 5/00

(52) U.S. Cl. CPC F01D 5/005; F05D 2230/60; F05D 2230/70

(57) ABSTRACT

A method (200) for determining assembly positions for available blades around a disc hub is disclosed. The method (200) includes determining (202) n number of sectors(S) of a bladed disc, receiving (204) a set of blades (BD), receiving (206) a set of corresponding geometric parameter values, sorting (208) the set of blades (BD) based on the set of geometric parameter values, forming (210) a first sequence of m number of groups based on the n number of the sectors(S), and distributing (212) the sorted set of blades (BD) into the m number of the groups. The method (200) further includes rearranging (214) the first sequence of the m number of the groups into a second sequence, and determining (216) set of assembly positions of the set of blades (BD) around the disc hub at least based on the second sequence.

### FIELD OF THE DISCLOSURE

The present disclosure relates to a method for determining assembly positions for available blades around a disc hub.

### BACKGROUND

Typically, service run hardware, such as blades, may need repairs or may have to be discarded. For example, when the blades are shorter than accepted limits. Using these blades may negatively impact a functional behaviour of an engine (e.g., a gas turbine engine) or impact any other design criteria. Repairs and discarding blades may increase costs and/or wastage. Hence, there may be a requirement to reuse the service run blades without compromising the functional behaviour of the engine or the other design criteria.

### SUMMARY

According to a first aspect of the present disclosure, there is provided a method for determining assembly positions for available blades around a disc hub of a bladed disc. The method includes determining n number of sectors of the bladed disc and receiving a set of blades. The set of blades includes each of the available blades or a subset of the available blades. The method further includes receiving a set of geometric parameter values corresponding to the set of blades. The method further includes sorting the set of blades based on the set of geometric parameter values in an ascending order or a descending order and forming a first sequence of m number of groups based on the n number of the sectors. The method further includes distributing the sorted set of blades into the m number of the groups, such that each group from the m number of the groups sequentially receives the n number of the blades from the sorted set of blades in the first sequence, and each of the sectors at least includes one blade from each of the groups. The method further includes rearranging the first sequence of the m number of the groups into a second sequence of the m number of the groups. The second sequence of the m number of the groups sequentially includes a first group, a m^{th} group, a second group, a (m−1)^{th} group, until a ((m/2)+1)^{th} group if m is an even number. The second sequence of the m number of the groups sequentially includes the first group, the m^{th} group, the second group, the (m−1)^{th} group, until a ((m+1)/2)^{th} group if m is an odd number. The method further includes determining set assembly positions of the set of blades around the disc hub for each blade of the set of blades at least based on the second sequence. Therefore, the method may determine the assembly positions from the available blades around the disc hub. The available blades may include blades that may be, for example, shorter than accepted limits. This is because, a moving average of the geometric parameter values (e.g., the tip lengths) in the assembly positions may be equal to or greater than the accepted limits. Thus, the assembly positions of the blades determined by the method may not negatively impact a functional behaviour of an engine (e.g., a gas turbine engine) or impact any other design criteria.

In some embodiments, the available blades include x number of the available blades. Determining the n number of the sectors of the bladed disc further includes receiving a predefined number of sectors and using the predefined number of sectors as the n number of the sectors if the predefined number of sectors is a factor of the x number of the available blades.

In some embodiments, the set of blades includes each of the available blades. Therefore, the method may provide an efficient arrangement including each of the available blades.

In some embodiments, the available blades include x number of the available blades, and determining the n number of the sectors of the bladed disc further includes receiving a predefined number of sectors, and removing y number of discard blades if the predefined number of sectors is a not factor of the x number of the available blades, such that a difference between the x number of the available blades and the y number of the discard blades is a multiple of the predefined number of sectors. Determining the n number of the sectors of the bladed disc further includes using the predefined number of sectors as the n number of the sectors if the y number of the discard blades is less than a predefined discard number, increasing the predefined number of sectors to an updated number of sectors if the y number of the discard blades is greater than or equal to the predefined discard number, until the y number of the discard blades is less than the predefined discard number, and using the updated number of sectors as the n number of the sectors. Therefore, in case the predefined number of sectors is the not factor of the x number of the available blades, the n number of the sectors may be adjusted and updated, such that a distribution of the set of blades is uniform in the n number of the sectors.

In some embodiments, the set of blades includes the subset of the available blades. The subset includes remaining available blades from the available blades after removing the discard blades. As discussed before, the method may therefore ensure that the distribution of the set of blades is uniform in the n number of the sectors.

In some embodiments, the method includes receiving full set of geometric parameter values corresponding to the x number of the available blades, such that each of the x number of the available blades has a corresponding geometric parameter value and determining an average value of the full set of geometric parameter values of the x number of the available blades. In some embodiments, removing the y number of the discard blades further includes selecting the y number of the discard blades from the x number of the available blades having the corresponding geometric parameter values closer to the average value of the full set of geometric parameter values than the other available blades from the x number of the available blades.

In some embodiments, the method includes determining discard assembly positions of the discard blades from the remaining assembly positions around the disc hub for each discard blade of the discard blades after determining the set assembly positions for each blade of the set of blades. The discard blades can be varied anywhere around the bladed disc as their geometric parameter values are closer to the average value of the full set of geometric parameter values.

In some embodiments, the method further includes removing locking blades from the x number of the available blades before determining the n number of the sectors of the bladed disc. Each locking blade has a respective fixed assembly position. The method further includes adding the locking blades in the respective fixed assembly positions. The locking blades are used to lock the blades and prevent the blades from sliding annularly. Therefore, the locking blades may also be removed and then replaced back into the respective fixed assembly positions.

In some embodiments, the method further includes confirming that current assembly positions of the available blades around the disc hub are conforming to a conformance check when the locking blades are in the respective fixed assembly positions, one or more undersized blades from the set of blades having the corresponding geometric parameter values less than a predetermined minimum value are not disposed between the locking blades, and the set assembly positions of the one or more undersized blades are uniformly distributed around the disc hub. Therefore, the method may check if the current assembly positions of the available blades around the disc hub achieve design requirements for the engine.

In some embodiments, the method further includes determining that current assembly positions of the available blades around the disc hub are not conforming to a conformance check when the locking blades are not in the respective fixed assembly positions, one or more undersized blades from the set of blades has the corresponding geometric parameter values less than a predetermined minimum value are disposed between the locking blades, or the set assembly positions of the one or more undersized blades are not uniformly distributed around the disc hub. The method further includes determining updated assembly positions of the available blades around the disc hub by swapping positions of at least one pair of blades from the available blades around the disc hub for each permutation of possible swapping positions of at least one pair of blades from the available blades to obtain conforming assembly positions of the available blades around the disc hub, determining if the updated assembly positions of the available blades are more conforming than previously determined assembly positions after each permutation, and accepting the swapped positions of the at least one pair of blades from the available blades around the disc hub if the updated assembly positions of the available blades are more conforming than previously determined assembly positions after each permutation, and rejecting the swapped positions of the at least one pair of blades from the available blades around the disc hub if the updated assembly positions of the available blades are not more conforming than the previously determined assembly positions after each permutation.

Therefore, if the current assembly positions of the available blades around the disc hub do not achieve the design requirements, the method may determine the updated assembly positions which may be more conforming than the previous assembly positions.

In some embodiments, swapping positions of the at least one pair of blades from the available blades around the disc hub includes swapping any two discard blades with each other, swapping any two locking blades with each other, or swapping at least one blade of a sector from the sectors with at least one blade of another sector from the sectors while keeping the groups of the swapped blades same. In some embodiments, swapping positions of the at least one pair of blades further includes swapping each blade of a sector from the sectors with each blade of another sector from the sectors while keeping the groups of the swapped blades same, or swapping each blade of a group from the groups with each blade of another group from the groups while keeping the sectors of the swapped blades same.

Therefore, by swapping positions the assembly positions, the conforming assembly positions of the available blades around the disc hub may be achieved without negatively impacting the moving average of the geometric parameter values in the assembly positions.

In some embodiments, the method further includes confirming that the conforming assembly positions of the available blades around the disc hub is balanced. Therefore, the method may check if the conforming assembly positions of the available blades around the disc hub achieve suitable balance requirements for the engine.

In some embodiments, the method further includes determining that the conforming assembly positions of the available blades around the disc hub is not balanced and determining updated assembly positions of the available blades around the disc hub by swapping positions of at least one pair of blades from the available blades around the disc hub for each permutation of possible swapping positions of at least one pair of blades from the available blades to obtain balanced and conforming assembly positions of the available blades around the disc hub. In some embodiments, the method further includes determining if the updated assembly positions of the available blades are more balanced and more conforming than previously determined assembly positions after each permutation and accepting the swapped positions of the at least one pair of blades from the available blades around the disc hub if the updated assembly positions of the available blades are more balanced and more conforming than previously determined assembly positions after each permutation, and rejecting the swapped positions of the at least one pair of blades from the available blades around the disc hub if the updated assembly positions of the available blades are not more balanced or not more conforming than previously determined assembly positions after each permutation.

Therefore, if the conforming assembly positions of the available blades around the disc hub do not achieve the balance requirements, the method may further determine the updated assembly positions which may be more balanced than the previous assembly positions. Further, the method may also ensure that the updated assembly positions still conform to the design requirements.

In some embodiments, the set of geometric parameter values includes a set of tip lengths corresponding to the set of blades, and sorting the set of blades based on the set of geometric values includes sorting the set of blades based on the set of tip lengths in the ascending order or the descending order.

According to a second aspect of the present disclosure, there is provided a non-transitory computer-readable storage medium including instructions that, when executed, cause at least one processor to perform the method of the first aspect.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 illustrates a schematic diagram of a system for determining assembly positions for available blades around a disc hub of a bladed disc, according to an embodiment of the present disclosure;

FIG. 2 illustrates a flowchart of a method for determining the assembly positions for the available blades around the disc hub, according to an embodiment of the present disclosure;

FIG. 3 illustrates a flowchart of a method for determining the assembly positions of the available blades around the disc hub, according to an embodiment of the present disclosure;

FIG. 4 illustrates an exemplary chart showing a rearranged set of blades;

FIG. 5 illustrates an exemplary plot showing an arrangement of the set of blades of FIG. 4 in the disc hub;

FIG. 6 illustrates a flowchart of a method for determining the assembly positions of the available blades, according to an embodiment of the present disclosure;

FIG. 7 illustrates flowcharts of methods for checking and determining conformance of the assembly positions of the available blades around the disc hub, according to an embodiment of the present disclosure;

FIGS. 8A-8D illustrate exemplary plots showing different possible swapping positions;

FIGS. 9A and 9B illustrate exemplary plots showing different moving average values of geometric parameter values of the available blades in the assembly positions; and

FIG. 10 illustrates a flowchart of method for checking out of balance and the conformance of the assembly positions of the available blades, according to an embodiment of the present disclosure.

### DETAILED DESCRIPTION

Aspects and embodiments of the present disclosure will now be discussed with reference to the accompanying figures. Further aspects and embodiments will be apparent to those skilled in the art.

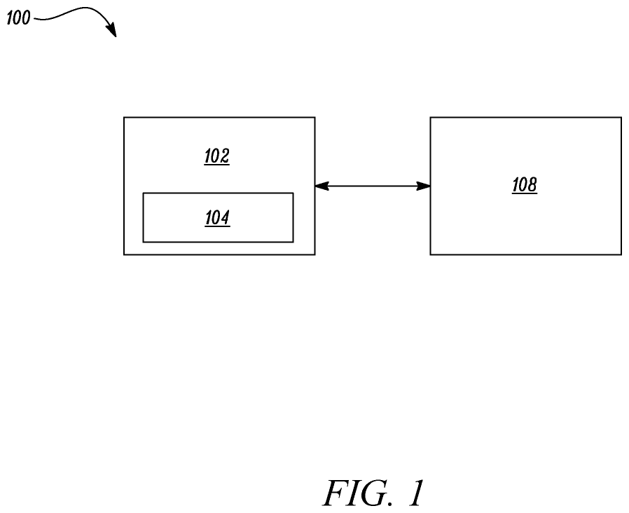

FIG. 1 illustrates a schematic diagram of a system 100 for determining assembly positions for available blades around a disc hub of a bladed disc, according to an embodiment of the present disclosure. The system 100 includes at least one processor 108 and a non-transitory computer-readable storage medium 102. In some embodiments, the non-transitory computer-readable storage medium 102 may correspond to a tangible medium, such as the data storage media, and may be part of a memory (not shown). In some embodiments, the at least one processor 108 and the memory may be part of a computing device (not shown) having a user interface (not shown) communicably coupled to the at least one processor 108. The user interface may include an input device and/or an output device. In some examples, the user interface may include a keyboard, a mouse, a display, and the like. A user or an operator may interact with the user interface to enter an input information or to obtain an output information. The non-transitory computer-readable storage medium 102 includes instructions 104 that, when executed, cause the at least one processor 108 to perform a method as will be disclosed herewith. In other words, the method of the present disclosure is configured to be performed by the at least one processor 108.

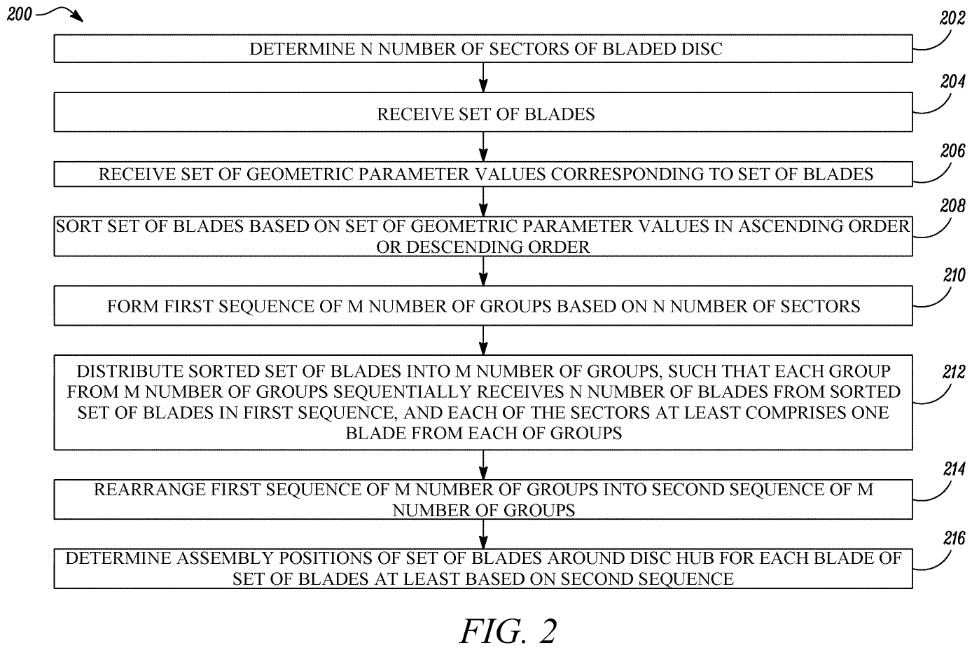

FIG. 2 shows a flowchart of a method 200 for determining the assembly positions for the available blades around the disc hub of the bladed disc, according to an embodiment of the present disclosure.

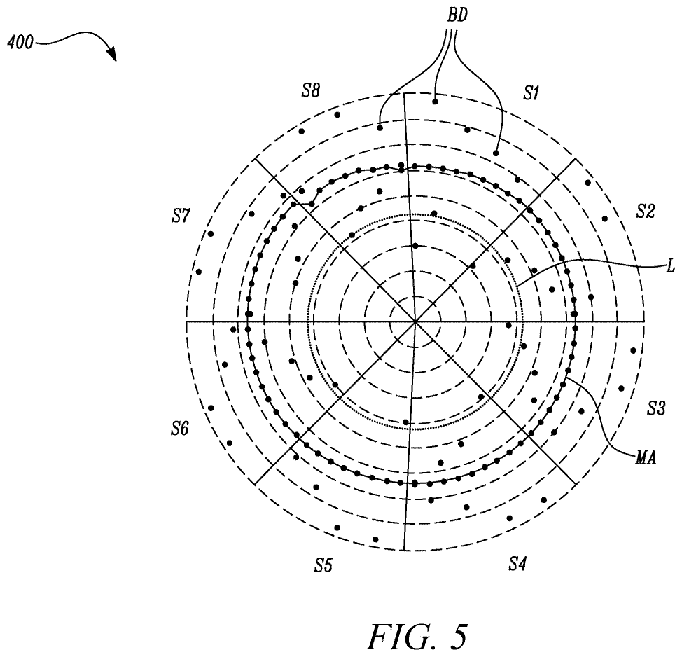

At step 202, the method 200 includes determining n number of sectors (shown as S1-S8 in FIG. 5) of the bladed disc. The sectors S1-S8 may be collectively referred to as “the sectors S” herein. At step 204, the method 200 includes receiving a set of blades BD (shown in FIG. 5). The set of blades BD includes each of the available blades or a subset of the available blades.

In some embodiments, the available blades include x number of the available blades. Determining the n number of the sectors S of the bladed disc further includes receiving a predefined number of the sectors S and using the predefined number of the sectors S as the n number of the sectors S if the predefined number of the sectors S is a factor of the x number of the available blades. In such embodiments, the set of blades BD includes each of the available blades.

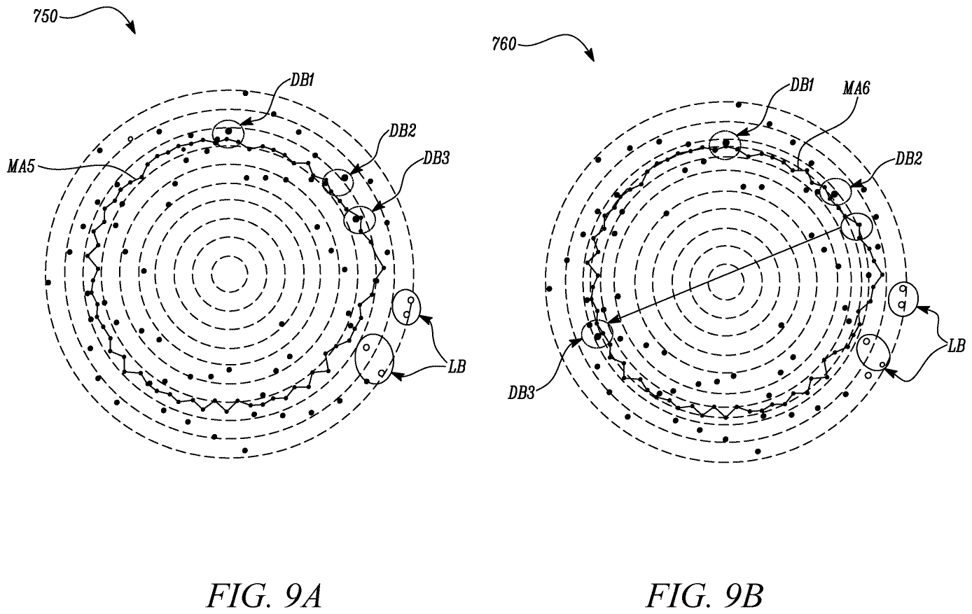

In some embodiments, determining the n number of the sectors S of the bladed disc further includes receiving the predefined number of the sectors S and removing y number of discard blades DB1, DB2, DB3 (shown in FIG. 9A, and collectively referred to as the “discard blades DB”) if the predefined number of the sectors S is a not factor of the x number of the available blades, such that a difference between the x number of the available blades and the y number of the discard blades DB is a multiple of the predefined number of sectors S.

In some embodiments, determining the n number of the sectors S of the bladed disc further includes using the predefined number of the sectors S as the n number of the sectors S if the y number of the discard blades DB is less than a predefined discard number and increasing the predefined number of the sectors S to an updated number of sectors S if the y number of the discard blades DB is greater than or equal to the predefined discard number, until the y number of the discard blades DB is less than the predefined discard number. In some embodiments, determining the n number of the sectors S of the bladed disc further includes using the updated number of the sectors S as the n number of the sectors S.

As discussed above, in some embodiments, the set of blades BD includes the subset of the available blades. The subset of the available blades includes remaining blades from the available blades after removing the discard blades DB.

In some embodiments, the method 200 further includes receiving full set of geometric parameter values corresponding to the x number of the available blades, such that each of the x number of the available blades has a corresponding geometric parameter value and determining an average value of the full set of geometric parameter values of the x number of the available blades. Removing the y number of the discard blades DB further includes selecting the y number of the discard blades DB from the x number of the available blades having the corresponding geometric parameter values closer to the average value of the full set of geometric parameter values than the other available blades from the x number of the available blades.

At step 206, the method 200 includes receiving a set of geometric parameter values corresponding to the set of blades BD. At step 208, the method 200 includes sorting the set of blades BD based on the set of geometric parameter values in an ascending order or a descending order. In some embodiments, the set of geometric parameter values includes a set of tip lengths corresponding to the set of blades BD, and sorting the set of blades BD based on the set of geometric values includes sorting the set of blades BD based on the set of tip lengths in the ascending order or the descending order.

At step 210, the method 200 includes forming a first sequence of m number of groups based on the n number of the sectors S. At step 212, the method 200 includes distributing the sorted set of blades BD into the m number of the groups, such that each group from the m number of the groups sequentially receives the n number of the blades BD from the sorted set of blades BD in the first sequence, and each of the sectors S at least includes one blade from each of the groups.

At step 214, the method 200 includes rearranging the first sequence of the m number of the groups into a second sequence of the m number of the groups. The second sequence of the m number of the groups sequentially includes a first group, a m^{th} group, a second group, a (m−1)^{th} group, until a ((m/2)+1)^{th} group if m is an even number. The second sequence of the m number of the groups sequentially includes the first group, the m^{th} group, the second group, the (m−1)^{th} group, until a ((m+1)/2)^{th} group if m is an odd number.

At step 216, the method 200 includes determining set of assembly positions of the set of blades BD around the disc hub for each blade of the set of blades BD at least based on the second sequence.

In some embodiments, the method 200 further includes determining discard assembly positions of the discard blades DB from the remaining assembly positions around the disc hub for each discard blade of the discard blades DB after determining the set assembly positions for each blade of the set of blades BD.

In some embodiments, the method 200 further includes removing locking blades LB (shown in FIG. 9A) from the x number of the available blades before determining the n number of the sectors S of the bladed disc. Each locking blade LB has a respective fixed assembly position. In some embodiments, the method 200 further includes adding the locking blades LB in the respective fixed assembly positions.

In some embodiments, the method 200 further includes confirming that current assembly positions of the available blades around the disc hub are conforming to a conformance check when the locking blades LB are in the respective fixed assembly positions, one or more undersized blades from the set of blades BD having the corresponding geometric parameter values less than a predetermined minimum value are not disposed between the locking blades LB, and the set assembly positions of the one or more undersized blades are uniformly distributed around the disc hub.

In some embodiments, the method 200 includes determining that the current assembly positions of the available blades around the disc hub are not conforming to the conformance check when the locking blades LB are not in the respective fixed assembly positions, the one or more undersized blades from the set of blades BD having the corresponding geometric parameter values less than the predetermined minimum value are disposed between the locking blades LB, or the set assembly positions of the one or more undersized blades are not uniformly distributed around the disc hub. In some embodiments, the method 200 further includes determining updated assembly positions of the available blades around the disc hub by swapping positions of at least one pair of blades from the available blades around the disc hub for each permutation of possible swapping positions of the at least one pair of blades from the available blades to obtain conforming assembly positions of the available blades around the disc hub.

In some embodiments, the method 200 further includes determining if the updated assembly positions of the available blades are more conforming than previously determined assembly positions after each permutation, and accepting the swapped positions of the at least one pair of blades from the available blades around the disc hub if the updated assembly positions of the available blades are more conforming than previously determined assembly positions after each permutation, and rejecting the swapped positions of the at least one pair of blades from the available blades around the disc hub if the updated assembly positions of the available blades are not more conforming than the previously determined assembly positions after each permutation.

In some embodiments, swapping positions of the at least one pair of blades from the available blades around the disc hub includes swapping any two discard blades DB with each other, swapping any two locking blades LB with each other, or swapping at least one blade of a sector from the sectors S with at least one blade of another sector from the sectors S while keeping the groups of the swapped blades same.

In some embodiments, swapping positions of the at least one pair of blades from the available blades around the disc hub includes swapping each blade of a sector from the sectors S with each blade of another sector from the sectors S while keeping the groups of the swapped blades same, or swapping each blade of a group from the groups with each blade of another group from the groups while keeping the sectors S of the swapped blades same.

In some embodiments, the method 200 further includes confirming that the conforming assembly positions of the available blades around the disc hub is balanced.

In some embodiments, the method 200 includes determining that the conforming assembly positions of the available blades around the disc hub is not balanced, and determining updated assembly positions of the available blades around the disc hub by swapping positions of at least one pair of blades from the available blades around the disc hub for each permutation of possible swapping positions of at least one pair of blades from the available blades to obtain balanced and conforming assembly positions of the available blades around the disc hub.

The method 200 further includes determining if the updated assembly positions of the available blades are more balanced and more conforming than previously determined assembly positions after each permutation and accepting the swapped positions of the at least one pair of blades from the available blades around the disc hub if the updated assembly positions of the available blades are more balanced and more conforming than previously determined assembly positions after each permutation, and rejecting the swapped positions of the at least one pair of blades from the available blades around the disc hub if the updated assembly positions of the available blades are not more balanced or not more conforming than previously determined assembly positions after each permutation.

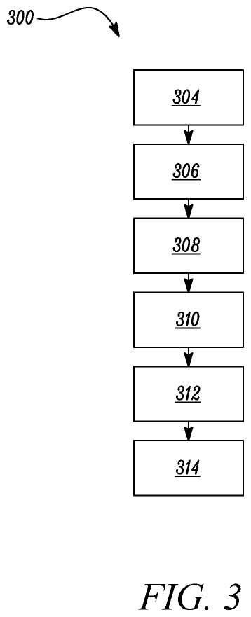

FIG. 3 illustrates a flowchart depicting a method 300 for determining the assembly positions of the available blades around the disc hub, according to an embodiment of the present disclosure.

Referring to FIGS. 1 and 3, at block 304, the method 300 includes receiving the set of blades BD. At block 306, the method 300 includes sorting the set of blades BD in the ascending order or the descending order. The set of blades BD may be sorted with respect to the geometric parameters of the set of blades BD.

At block 308, the method 300 includes setting the n number of sectors S of the bladed disc and a number of blades in each of the sectors S. At block 310, the method 300 includes forming the m number of groups for the set of blades BD such that each sector includes a blade from each of the m number of groups. Forming of the m number groups may result in the first sequence of the set of blades BD. At block 312, the method 300 includes rearranging the first sequence of the m number of the groups into the second sequence of the m number of the groups.

At block 314, the method 300 includes determining the set of assembly positions of the set of blades BD around the disc hub for each blade of the set of blades BD based on the second sequence.

Table 1 below shows exemplary set of blades 1-72 distributed in the first sequence of sectors S1-S8.

TABLE 1

| | Groups | | | | | | | | |
|---|---|---|---|---|---|---|---|---|---|
| Sectors | A | B | C | D | E | F | G | H | I |
| S1 | 72 | 64 | 56 | 48 | 40 | 32 | 24 | 16 | 8 |
| S2 | 71 | 63 | 55 | 47 | 39 | 31 | 23 | 15 | 7 |
| S3 | 70 | 62 | 54 | 46 | 38 | 30 | 22 | 14 | 6 |
| S4 | 69 | 61 | 53 | 45 | 37 | 29 | 21 | 13 | 5 |
| S5 | 68 | 60 | 52 | 44 | 36 | 28 | 20 | 12 | 4 |
| S6 | 67 | 59 | 51 | 43 | 35 | 27 | 19 | 11 | 3 |
| S7 | 66 | 58 | 50 | 42 | 34 | 26 | 18 | 10 | 2 |
| S8 | 65 | 57 | 49 | 41 | 33 | 25 | 17 | 9 | 1 |

Referring to FIG. 2 and Table 1, the geometric parameter values of the set of blades BD are received. In some embodiments, the geometric parameter values may be retrieved from the memory. In the given example, the set of blades BD are sorted in the descending order. Specifically, the blade 72 has the longest tip length and the blade 1 has the shortest tip length. In some examples, the predefined number of sectors may be 8, i.e., the sectors S1-S8. The set of blades BD are distributed into 9 groups, i.e., groups A, B, . . . , I, such that each group A-I sequentially receives 8 number of blades from sorted set of blades 72-1 in the first sequence (i.e., the descending order), and each of the sectors S1, S2, . . . , S8 at least includes one blade from each of the groups A-I.

According to the method 200, 300, the first sequence of groups A-I is rearranged into the second sequence. Since the number of groups A-I is an odd number, i.e., 9, the second sequence of the m number of the groups sequentially comprises the first group, the m^{th} group, the second group, the (m−1)^{th} group, until a ((m+1)/2)^{th} group as shown in Table 2 below.

TABLE 2

| | Groups | | | | | | | | |
|---|---|---|---|---|---|---|---|---|---|
| Sectors | A | I | B | H | C | G | D | F | E |
| S1 | 72 | 8 | 64 | 16 | 56 | 24 | 48 | 32 | 40 |
| S2 | 71 | 7 | 63 | 15 | 55 | 23 | 47 | 31 | 39 |
| S3 | 70 | 6 | 62 | 14 | 54 | 22 | 46 | 30 | 38 |
| S4 | 69 | 5 | 61 | 13 | 53 | 21 | 45 | 29 | 37 |
| S5 | 68 | 4 | 60 | 12 | 52 | 20 | 44 | 28 | 36 |
| S6 | 67 | 3 | 59 | 11 | 51 | 19 | 43 | 27 | 35 |
| S7 | 66 | 2 | 58 | 10 | 50 | 18 | 42 | 26 | 34 |
| S8 | 65 | 1 | 57 | 9 | 49 | 17 | 41 | 25 | 33 |

Accordingly, as shown in Table 2, the second sequence includes groups in order such that each of the sectors S1-S8 includes the blades sequentially from the Group A, the Group I, the Group B, the Group H, the Group C, the Group G, the Group D, the Group F, and the Group E.

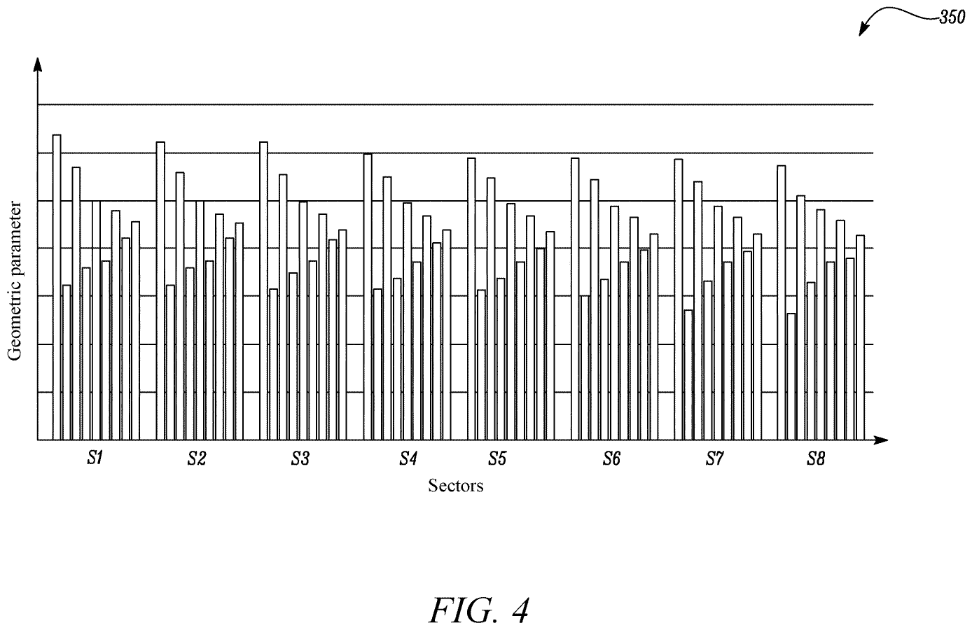

FIG. 4 illustrates an exemplary chart 350 showing the rearranged set of blades BD of Table 2 in a visual format. As can be seen from the chart 350, each of the sectors S1-S8 includes one blade from each of the groups A-I, arranged in the second sequence, as shown in Table 2.

FIG. 5 shows an exemplary plot 400 showing an arrangement of the set of blades BD of FIG. 4 around the disc hub based on the second sequence.

The plot 400 further shows a moving average value MA of the geometric parameter values (e.g., the tip lengths) in the arrangement of the set of blades BD distributed in the sectors S1-S8 based on the geometric parameter values of the set of blades BD according to the method 200, 300 discussed with reference to FIGS. 2 and 3, respectively. The plot 400 further shows a lower limit L of the geometric parameter values (e.g., the tip lengths) allowable in the bladed disc.

As can be seen in the plot 400, even when the arrangement of the set of blades BD includes a few blades having the geometric parameter values lower than the lower limit L, since the moving average value MA of the geometric parameter values in the arrangement of the set of blades BD is greater than the lower limit L, the arrangement can include such blades without negatively impacting a functional behaviour of an engine (e.g., a gas turbine engine).

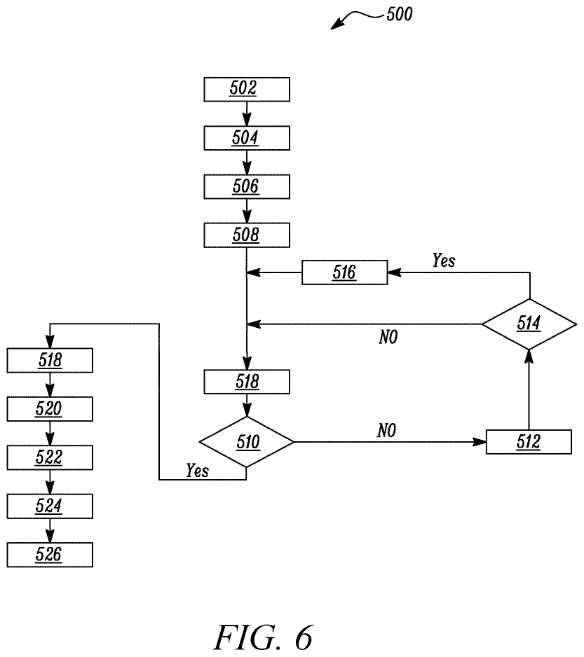

FIG. 6 illustrates a flowchart of a method 500 for determining the assembly positions of the available blades, according to an embodiment of the present disclosure. Exemplary discard blades DB are shown in FIGS. 9A and 9B.

At block 502, the method 500 includes receiving the x number of the available blades. At block 504, the method 500 includes removing the locking blades LB from the x number of the available blades. The method further 500 includes receiving the full set of geometric parameter values corresponding to the x number of the available blades, such that each of the x number of the available blades has corresponding geometric parameter value. The method 500 further includes determining the average value of the full set of geometric parameter values of the x number of the available blades. At block 506, the method 500 includes sorting the set of blades BD based on the set of geometric parameter values in the ascending order or the descending order. At block 508, the method 500 includes receiving a predefined number of sectors S.

At block 510, the method 500 includes determining if a size of each of the sectors S is integer or not. The size of each of the sectors S may be determined by dividing the remaining blades after removing the locking blades by the predefined number of sectors S. If the size is not integer, the method 500 moves to block 512, in which, the method 500 includes removing the y number of the discard blades DB if the predefined number of sectors S is a not factor of the x number of the available blades, such that a difference between the x number of the available blades and the y number of the discard blades DB is a multiple of the predefined number of sectors S. The subset includes the remaining available blades from the available blades after removing the discard blades DB. In some embodiments, removing the y number of the discard blades DB further includes selecting the y number of the discard blades DB from the x number of the available blades having the corresponding geometric parameter values closer to the average value of the full set of geometric parameter values than the other available blades from the x number of the available blades.

At block 514, the method 500 includes determining if the number discard blades DB is equal to or more than the predefined number of sectors S. The method 500 includes using the predefined number of sectors S as the n number of the sectors S if the y number of the discard blades DB is less than the predefined discard number. At block 516, the method 500 further includes increasing the predefined number of the sectors S to an updated number of sectors if the y number of the discard blades DB is greater than or equal to the predefined discard number, until the y number of the discard blades DB is less than the predefined discard number. The method 500 further includes using the updated number of sectors S as the n number of the sectors S. If, at block 514, the number of discard blades DB is less than the number of sectors S, then the n number of the sectors S remains unchanged.

At block 518, the method 500 includes distributing the sorted set of blades BD (without the discard blades DB and the locking blades LB) into the m number of the groups, such that each group from the m number of the groups sequentially receives the n number of the blades from the sorted set of blades in the first sequence. At block 520, the method 500 includes rearranging the first sequence of the m number of groups into the second sequence of m number of groups, such that the set of blades BD are arranged in the corresponding assembly positions.

At block 522, the method 500 includes determining the discard assembly positions of the discard blades DB from the remaining assembly positions around the disc hub for each discard blade of the discard blades DB. At block 524, the method 500 further includes adding the locking blades LB in the respective fixed assembly positions. At block 526, the method 500 includes accepting the assembly positions with the discard blades DB and the locking blades LB.

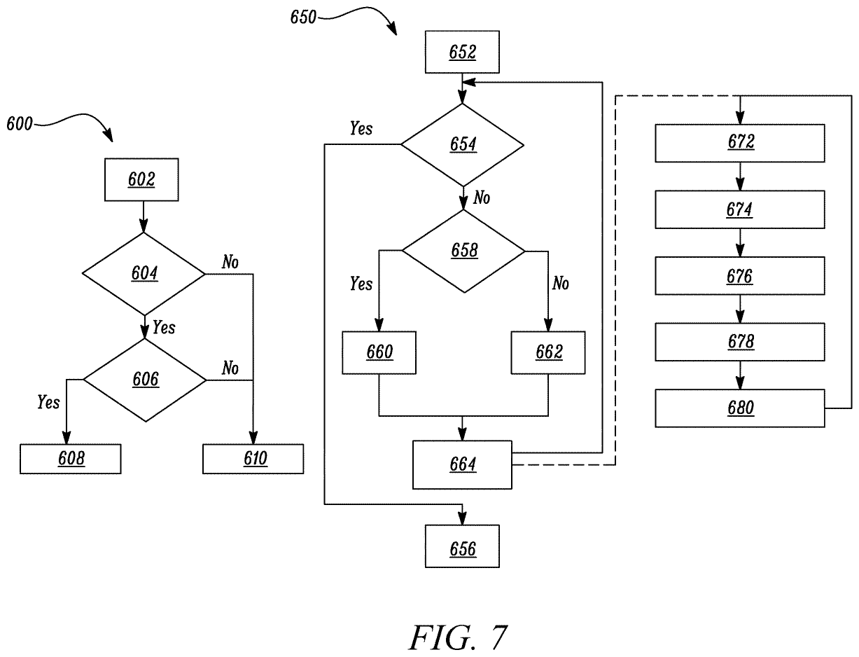

FIG. 7 illustrates a flowchart of a method 600 for checking conformance of the assembly positions of the available blades around the disc hub, according to an embodiment of the present disclosure. The method 600 may be performed after determining the assembly positions of the available blades including discard blades DB as explained in FIGS. 2 and 6.

At block 602, the method 600 includes confirming that the current assembly positions of the available blades around the disc hub are conforming to the conformance check. At block 604, the method 600 includes determining if the locking blades LB are in respective fixed assembly positions or not. If the locking blades LB are in the respective fixed assembly positions, the method moves to block 606. At block 606, the method 600 includes determining if undersize rules are met by the current assembly positions or not. If at block 606, the undersize rules are met, then the method moves to block 608 where the assembly positions are considered to confirm the conformance check. If at block 606, the undersize rules are not met, then the assembly positions are not confirming the conformance check and the method 600 moves to block 610. At block 604, if the locking blades are not at the respective fixed assembly positions, then too the method 600 moves to block 610 where the assembly positions are not confirming the conformance check.

FIG. 7 further illustrates a flowchart of a method 650 for determining the conforming assembly positions of the available blades around the disc hub, according to an embodiment of the present disclosure. At block 652, the method 650 includes receiving the current assembly positions of the available blades around the disc hub.

At block 654, the method 650 includes confirming that the current assembly positions of the available blades around the disc hub are conforming to the conformance check when the locking blades LB are in the respective fixed assembly positions, the one or more undersized blades from the set of blades BD having the corresponding geometric parameter values less than the predetermined minimum value are not disposed between the locking blades LB, and the set assembly positions of the one or more undersized blades are uniformly distributed around the disc hub. In some examples, at block 654, the method 650 may use the method 600 for confirming if the current assembly positions of the available blades around the disc hub are conforming to the conformance check.

If the current assembly positions of the available blades around the disc hub are conforming at block 654, then the method 650 moves to block 656, where the current assembly positions are accepted as the conforming assembly positions. If the current assembly positions are not conforming at block 654, then the method moves to block 658.

At block 658, the method 650 further includes determining the updated assembly positions of the available blades around the disc hub by swapping positions of at least one pair of blades from the available blades around the disc hub for each permutation of possible swapping positions of at least one pair of blades from the available blades to obtain the conforming assembly positions of the available blades around the disc hub.

In some embodiments, the method 650 further includes determining if the updated assembly positions of the available blades are more conforming than previously determined assembly positions after each permutation.

In some embodiments, swapping of the at least one pair of blades may be performed in a multiple ways. In some embodiments, swapping positions of the at least one pair of blades from the available blades around the disc hub includes swapping any two discard blades DB with each other, swapping any two locking blades LB with each other, or swapping at least one blade of a sector from the sectors with at least one blade of another sector from the sectors while keeping the groups of the swapped blades same. In some embodiments, swapping positions of the at least one pair of blades from the available blades around the disc hub further includes swapping each blade of a sector from the sectors S with each blade of another sector from the sectors while keeping the groups of the swapped blades same or swapping each blade of a group from the groups with each blade of another group from the groups while keeping the sectors of the swapped blades same.

At block 660, the method 650 includes accepting the swapped positions of the at least one pair of blades from the available blades around the disc hub if the updated assembly positions of the available blades are more conforming than previously determined assembly positions after each permutation. At block 662, the method 650 includes rejecting the swapped positions of the at least one pair of blades from the available blades around the disc hub if the updated assembly positions of the available blades are not more conforming than the previously determined assembly positions after each permutation.

After blocks 660, 662, the method 650 moves to block 664, where next swapping is performed. Swapping is performed at blocks 672, 674, 676, 678, 680. At block 672, the discard blades DB are swapped for all positions. At block 674, a pair of the sectors S are swapped. At block 676, the pair of blades from the sectors S are swapped. At block 678, all the blades of the sectors S are swapped. At block 680, each swapping of blocks 672, 674, 676, 678 is repeated for determining the more conforming assembly positions of the available blades.

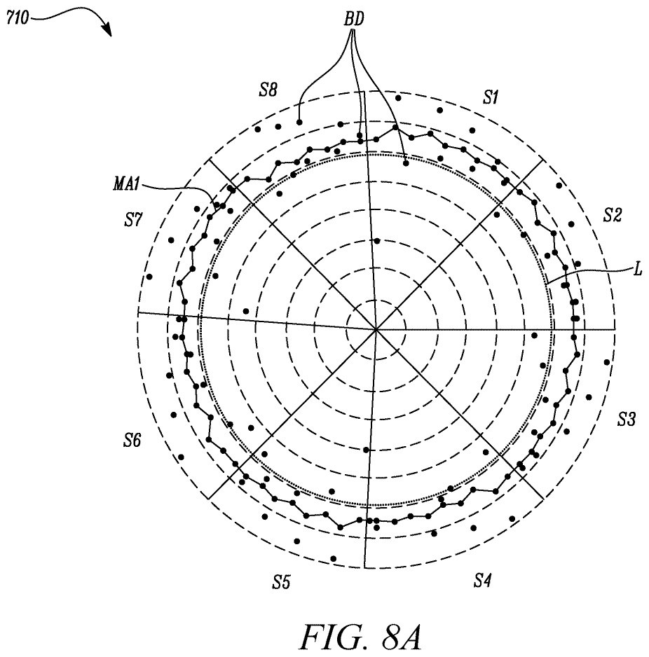

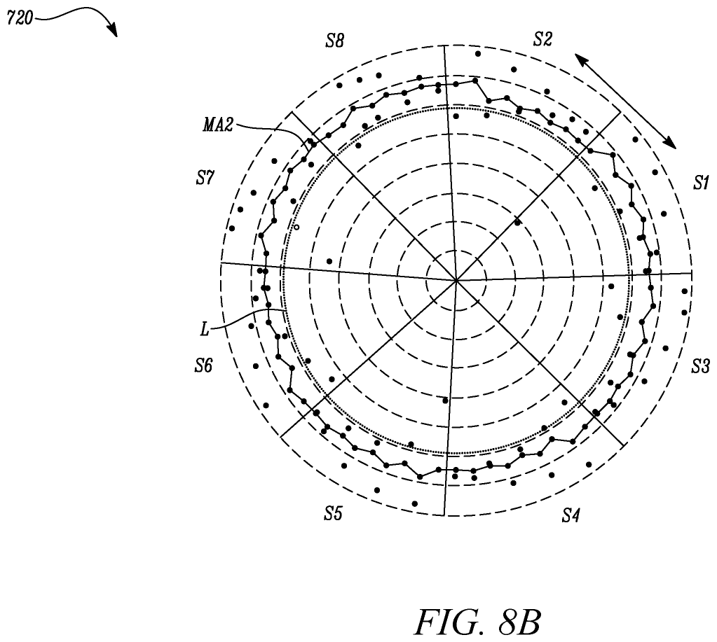

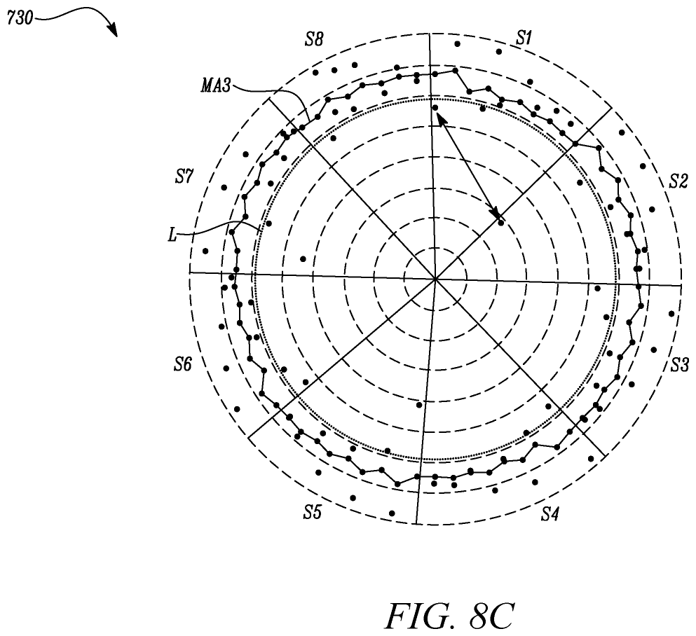

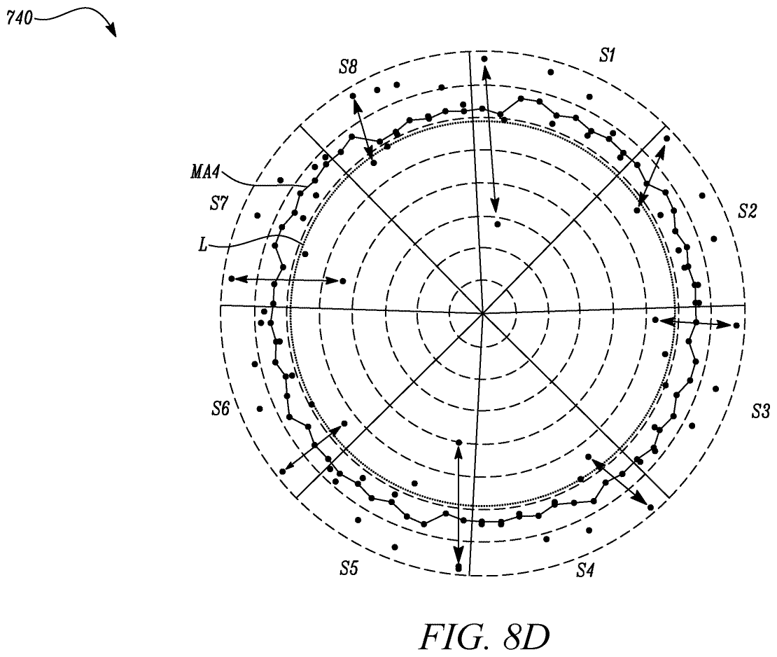

FIG. 8A shows an exemplary plot 710 illustrating an arrangement of the set of blades BD distributed in the sectors S1-S8. The plot 710 further includes a baseline moving average value MA1 of the geometric parameter values for the arrangement of the set of blades according to Table 2.

Table 3 provided below shows swapping of the blades of the sector S1 with the blades of the sector S2. It is to be noted that the blades in the remaining sectors S3-S8 remain same as shown in Table 2.

TABLE 3

| | Groups | | | | | | | | |
|---|---|---|---|---|---|---|---|---|---|
| Sectors | A | I | B | H | C | G | D | F | E |
| S2 | 71 | 7 | 63 | 15 | 55 | 23 | 47 | 31 | 39 |
| S1 | 72 | 8 | 64 | 16 | 56 | 24 | 48 | 32 | 40 |
| S3 | 70 | 6 | 62 | 14 | 54 | 22 | 46 | 30 | 38 |
| S4 | 69 | 5 | 61 | 13 | 53 | 21 | 45 | 29 | 37 |
| S5 | 68 | 4 | 60 | 12 | 52 | 20 | 44 | 28 | 36 |
| S6 | 67 | 3 | 59 | 11 | 51 | 19 | 43 | 27 | 35 |
| S7 | 66 | 2 | 58 | 10 | 50 | 18 | 42 | 26 | 34 |
| S8 | 65 | 1 | 57 | 9 | 49 | 17 | 41 | 25 | 33 |

FIG. 8B illustrates an exemplary plot 720 for the assembly positions of the set of blades BD in the sectors S1-S8 having the assembly positions as shown in Table 3. The plot 720 includes a moving average value MA2 of the geometric parameter values for the new assembly positions of the set of blades BD according to Table 3.

Table 4 provided below shows swapping of a first blade (e.g., the blade 72) of the sector S1 with a corresponding first blade (e.g., the blade 71) of the sector S2. It is to be noted that the blades in the remaining positions of the sectors S1-S2 and the remaining sectors S3-S8 remain same as shown in Table 2 and shown in the plot 710 of FIG. 8A.

TABLE 4

| | Groups | | | | | | | | |
|---|---|---|---|---|---|---|---|---|---|
| Sectors | A | I | B | H | C | G | D | F | E |
| S1 | 71 | 8 | 64 | 16 | 56 | 24 | 48 | 32 | 40 |
| S2 | 72 | 7 | 63 | 15 | 55 | 23 | 47 | 31 | 39 |
| S3 | 70 | 6 | 62 | 14 | 54 | 22 | 46 | 30 | 38 |
| S4 | 69 | 5 | 61 | 13 | 53 | 21 | 45 | 29 | 37 |
| S5 | 68 | 4 | 60 | 12 | 52 | 20 | 44 | 28 | 36 |
| S6 | 67 | 3 | 59 | 11 | 51 | 19 | 43 | 27 | 35 |
| S7 | 66 | 2 | 58 | 10 | 50 | 18 | 42 | 26 | 34 |
| S8 | 65 | 1 | 57 | 9 | 49 | 17 | 41 | 25 | 33 |

FIG. 8C illustrates an exemplary plot 730 for the assembly positions of the set of blades BD in the sectors S1-S8 having the assembly positions as illustrated in Table 4. The plot 730 includes a moving average value MA3 of the geometric parameter values for the new assembly positions of the set of blades BD according to Table 4.

Table 5 provided below shows swapping of the first group A with the second group I. Accordingly, the first and the second blades of each of the sectors S1-S8 are swapped. It is to be noted that the blades in the remaining positions of set of blades in the groups B-H remain same as shown in Table 2.

TABLE 5

| Sectors | I | A | B | H | C | G | D | F | E |
|---|---|---|---|---|---|---|---|---|---|
| S1 | 8 | 72 | 64 | 16 | 56 | 24 | 48 | 32 | 40 |
| S2 | 7 | 71 | 63 | 15 | 55 | 23 | 47 | 31 | 39 |
| S3 | 6 | 70 | 62 | 14 | 54 | 22 | 46 | 30 | 38 |
| S4 | 5 | 69 | 61 | 13 | 53 | 21 | 45 | 29 | 37 |
| S5 | 4 | 68 | 60 | 12 | 52 | 20 | 44 | 28 | 36 |
| S6 | 3 | 67 | 59 | 11 | 51 | 19 | 43 | 27 | 35 |
| S7 | 2 | 66 | 58 | 10 | 50 | 18 | 42 | 26 | 34 |
| S8 | 1 | 65 | 57 | 9 | 49 | 17 | 41 | 25 | 33 |

FIG. 8D illustrates an exemplary plot 740 for the assembly positions of the set of blades BD in the sectors S1-S8 having the assembly positions as shown in Table 5. The plot 740 includes a moving average value MA4 of the geometric parameter values for the new assembly positions of the set of blades BD according to Table 5.

FIGS. 9A and 9B illustrate exemplary plots 750, 760 showing moving average values of the geometric parameter values of the assembly blades including the discard blades DB1, DB2, DB3, according to an embodiment of the present disclosure. Specifically, FIG. 9A illustrates the plot 750 showing the assembly blades including the discard blades DB1, DB2, DB3 in their original assembly positions. The plot 750 shows a moving average value MA5 of the geometric parameter values for the assembly positions of the available blades including the discard blades DB1, DB2, DB3 at the corresponding discard assembly positions. The plot 750 further shows the locking blades LB at the respective fixed assembly positions around the disc hub. FIG. 9B illustrates the plot 760 representing the assembly blades including the discard blades DB1, DB2, DB3 in swapped assembly positions. Specifically, a discard assembly position of the discard blade DB3 is swapped with a blade of the set of blades BD in the bladed disc. The plot 760 includes a moving average value MA6 of the geometric parameter values for the assembly positions of the available blades including the swapped discard blade DB3. The plot 760 further shows the locking blades LB at the respective fixed assembly positions around the disc hub.

Referring to FIGS. 9A and 9B, the moving average values MA5 and MA6 are substantially the same. Since the geometrical parameters of the discard blades DB1, DB2, DB3 are closer to the average value of the geometrical parameter, swapping of any of the discard blades DB1, DB2, DB3 does not affect a moving average value of the geometric parameter values for the swapped positions.

Table 6 provided below shows changes in the moving average values of the geometric parameter values of the bladed disc before and after swapping the set of blades BD except swapping of the discard blades DB.

TABLE 6

| | Moving |
|---|---|
| Swap Type | Average Value |
| no Swap | X |
| Sector Swap S1-S2 | 0.98 X |
| Swapping 1st blade | 0.99 X |
| of sectors S1 and S2 | |
| Swapping of Group | 0.99 X |
| A and B | |

Where X represents a moving average value of an initial arrangement of the geometric parameter values for the available blades in the bladed disc before the swapping of the set of blades BD.

Table 7 provided below shows changes in the moving average values of the geometric parameter values for the bladed disc before and after swapping of the discard blades DB.

TABLE 7

| | Moving |
|---|---|
| Swap Type | Average Value |
| no Swap | X' |
| Swap Discard | X' |

Where X′ represents a moving average value of the geometric parameter values of an arrangement of the available blades in the bladed disc after the swapping of the set of blades BD and before swapping of the discard blades DB.

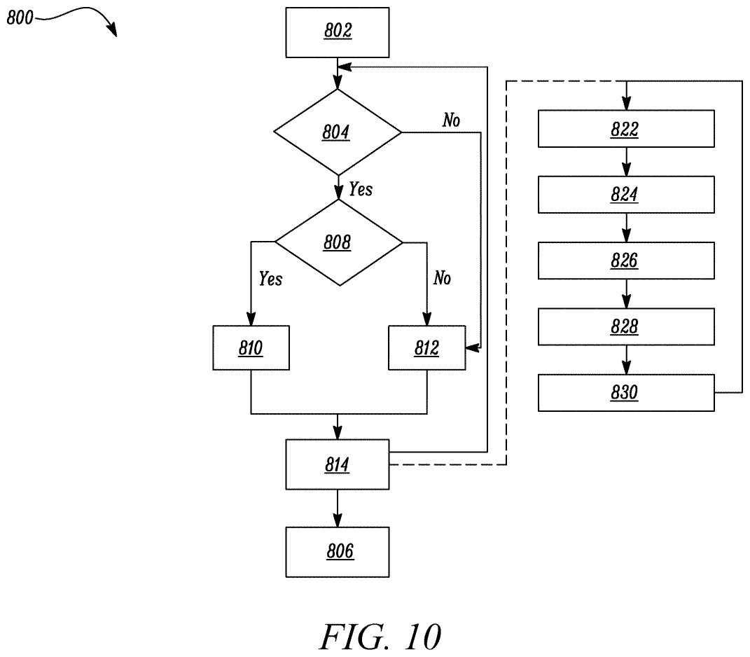

FIG. 10 illustrates a flowchart of method 800 for checking the out of balance and the conformance of the assembly positions of the available blades with the discard blades DB and the locking blades LB, according to an embodiment of the present disclosure. It is to be noted that the method 800 may be performed after performing the conformance check of the methods 600, 650 as illustrated in FIG. 7.

At block 802, the method 800 includes receiving the conforming assembly positions of the available blades around the disc hub are balanced. At block 804, the method 800 includes determining if the confirming positions of the available blades around the disc hub are balanced. If the conforming positions of the available blades are balanced, the method 800 moves to block 808. If the conforming positions of the available blades are not balanced, then the method 800 moves to block 812. At block 808, the method 800 determines the conformance check of the available blades. At block 810, the method 800 includes accepting the swapped positions of the at least one pair of blades from the available blades around the disc hub if the updated assembly positions of the available blades are more balanced and more conforming than previously determined assembly positions after each permutation. At block 812, the method 800 includes rejecting the swapped positions of the at least one pair of blades from the available blades around the disc hub if the updated assembly positions of the available blades are not more balanced or not more conforming than previously determined assembly positions after each permutation.

At block 814, the method 800 includes determining the updated assembly positions of the available blades around the disc hub by swapping positions of at least one pair of blades from the available blades around the disc hub for each permutation of possible swapping positions of at least one pair of blades from the available blades to obtain balanced and conforming assembly positions of the available blades around the disc hub. The swapping of the at least one pair of blades is shown in blocks 822, 824, 826, 828, 830. At block 822, swapping of the discard blades DB for all discard assembly positions is performed. At block 824, the pair of blades from the sectors S are swapped. At block 826, all the blades of the sectors S are swapped. At block 828, each of the set of blades BD among the sectors S is swapped. At block 830, each swapping of blocks 822, 824, 826, 828 is repeated for determining the more balanced and more conforming assembly positions of the available blades. At block 806, the more balanced and more conforming assembly positions are achieved.

In some embodiments, for determining the assembly positions of the set of blades BD in the bladed disc, additional parameters of one or more of the set of blades BD may be considered so that the assembly positions of the set of blades BD may confirm the conformance check, as well as the out of balance check. The additional parameters may include, for each of the set of blades BD, a blade profile, a mass, a vibration tolerance, a camber, a blade position, a shape, a chord length, a leading-edge radius, a thickness-to-chord ratio, a maximum thickness location, and the like.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for determining assembly positions for available blades around a disc hub of a bladed disc, the method comprising the steps of:
determining n number of sectors of the bladed disc;
receiving a set of blades, wherein the set of blades comprises each of the available blades or a subset of the available blades;
receiving a set of geometric parameter values corresponding to the set of blades;
sorting the set of blades based on the set of geometric parameter values in an ascending order or a descending order;
forming a first sequence of m number of groups based on the n number of the sectors;
distributing the sorted set of blades into the m number of the groups, such that each group from the m number of the groups sequentially receives the n number of the blades from the sorted set of blades in the first sequence, and each of the sectors at least comprises one blade from each of the groups;
rearranging the first sequence of the m number of the groups into a second sequence of the m number of the groups, wherein the second sequence of the m number of the groups sequentially comprises a first group, a m^{th} group, a second group, a (m−1)^{th} group, until a ((m/2)+1)^{th} group if m is an even number, and wherein the second sequence of the m number of the groups sequentially comprises the first group, the m^{th} group, the second group, the (m−1)^{th} group, until a ((m+1)/2)^{th} group if m is an odd number; and
determining set of assembly positions of the set of blades (BD) around the disc hub for each blade of the set of blades at least based on the second sequence.

2. The method of claim 1, wherein the available blades comprise x number of the available blades, and wherein determining the n number of the sectors of the bladed disc further comprises:
receiving a predefined number of the sectors; and
using the predefined number of the sectors as the n number of the sectors if the predefined number of the sectors is a factor of the x number of the available blades.

3. The method of claim 2, wherein the set of blades comprises each of the available blades.

4. The method of claim 1, wherein the available blades comprise x number of the available blades, and wherein determining the n number of the sectors of the bladed disc further comprises:
receiving a predefined number of the sectors;
removing y number of discard blades if the predefined number of the sectors is a not factor of the x number of the available blades, such that a difference between the x number of the available blades and the y number of the discard blades is a multiple of the predefined number of sectors;
using the predefined number of the sectors as the n number of the sectors if the y number of the discard blades is less than a predefined discard number;
increasing the predefined number of the sectors to an updated number of the sectors if the y number of the discard blades is greater than or equal to the predefined discard number, until the y number of the discard blades is less than the predefined discard number; and
using the updated number of the sectors as the n number of the sectors.

5. The method of claim 4, wherein the set of blades comprises the subset of the available blades, the subset comprising remaining available blades from the available blades after removing the discard blades.

6. The method of claim 4 further comprising:
receiving full set of geometric parameter values corresponding to the x number of the available blades, such that each of the x number of the available blades has a corresponding geometric parameter value; and
determining an average value of the full set of geometric parameter values of the x number of the available blades, wherein removing the y number of the discard blades further comprises selecting the y number of the discard blades from the x number of the available blades having the corresponding geometric parameter values closer to the average value of the full set of geometric parameter values than the other available blades from the x number of the available blades.

7. The method of claim 4, further comprising determining discard assembly positions of the discard blades from the remaining assembly positions around the disc hub for each discard blade of the discard blades after determining the set assembly positions for each blade of the set of blades.

8. The method of claim 4, further comprising:
removing locking blades from the x number of the available blades before determining the n number of the sectors of the bladed disc, each locking blade having a respective fixed assembly position; and
adding the locking blades in the respective fixed assembly positions.

9. The method of claim 8, further comprising confirming that current assembly positions of the available blades around the disc hub are conforming to a conformance check when the locking blades are in the respective fixed assembly positions, one or more undersized blades from the set of blades having the corresponding geometric parameter values less than a predetermined minimum value are not disposed between the locking blades, and the set assembly positions of the one or more undersized blades are uniformly distributed around the disc hub.

10. The method of claim 8, further comprising:
determining that current assembly positions of the available blades around the disc hub are not conforming to a conformance check when the locking blades are not in the respective fixed assembly positions, one or more undersized blades from the set of blades having the corresponding geometric parameter values less than a predetermined minimum value are disposed between the locking blades, or the set assembly positions of the one or more undersized blades are not uniformly distributed around the disc hub;
determining updated assembly positions of the available blades around the disc hub by swapping positions of at least one pair of blades from the available blades around the disc hub for each permutation of possible swapping positions of at least one pair of blades from the available blades to obtain conforming assembly positions of the available blades around the disc hub;
determining if the updated assembly positions of the available blades are more conforming than previously determined assembly positions after each permutation; and
accepting the swapped positions of the at least one pair of blades from the available blades around the disc hub if the updated assembly positions of the available blades are more conforming than previously determined assembly positions after each permutation, and rejecting the swapped positions of the at least one pair of blades from the available blades around the disc hub if the updated assembly positions of the available blades are not more conforming than the previously determined assembly positions after each permutation.

11. The method of claim 10, wherein swapping positions of the at least one pair of blades from the available blades around the disc hub comprises:
swapping any two discard blades with each other;
swapping any two locking blades with each other;
swapping at least one blade of a sector from the sectors with at least one blade of another sector from the sectors while keeping the groups of the swapped blades same;
swapping each blade of a sector from the sectors with each blade of another sector from the sectors while keeping the groups of the swapped blades same; or
swapping each blade of a group from the groups with each blade of another group from the groups while keeping the sectors of the swapped blades same.

12. The method of claim 10, further comprising confirming that the conforming assembly positions of the available blades around the disc hub are balanced.

13. The method of claim 10, further comprising:
determining that the conforming assembly positions of the available blades around the disc hub is not balanced;
determining updated assembly positions of the available blades around the disc hub by swapping positions of at least one pair of blades from the available blades around the disc hub for each permutation of possible swapping positions of at least one pair of blades from the available blades to obtain balanced and conforming assembly positions of the available blades around the disc hub;
determining if the updated assembly positions of the available blades are more balanced and more conforming than previously determined assembly positions after each permutation;
accepting the swapped positions of the at least one pair of blades from the available blades around the disc hub if the updated assembly positions of the available blades are more balanced and more conforming than previously determined assembly positions after each permutation, and rejecting the swapped positions of the at least one pair of blades from the available blades around the disc hub if the updated assembly positions of the available blades are not more balanced or not more conforming than previously determined assembly positions after each permutation.

14. The method of claim 1, wherein the set of geometric parameter values comprises a set of tip lengths corresponding to the set of blades, and sorting the set of blades based on the set of geometric values comprises sorting the set of blades based on the set of tip lengths in the ascending order or the descending order.

15. A non-transitory computer-readable storage medium comprising instructions that, when executed, cause at least one processor to perform the method of claim 1.
